(19) United States
(12) Patent Application Publication
(10) Pub. No.: US 2026/0054991 A1
(43) Pub. Date: Feb. 26, 2026

(54) GRAPHENE-BASED PRECURSOR STRUCTURES

(71) Applicant: Robert Bosch Gmbh, Stuttgart (DE)

(72) Inventors: Nicola MOLINARI, Somerville, MA (US); Jonathan BRAATEN, Sunnyvale, CA (US); Bjoern STUEHMEIER, Santa Clara, CA (US); Lei CHENG, San Jose, CA (US); Karim GADELRAB, Watertown, MA (US); Shirin MEHRAZI, San Jose, CA (US)

(21) Appl. No.: 18/813,418

(22) Filed: Aug. 23, 2024

(51) Int. Cl. C01B 32/194

(52) U.S. Cl. CPC C01B 32/194; C01P 2004/01; C01P 2006/12; C01P 2006/16

(57) ABSTRACT

A method of increasing porosity of graphene-based precursors including wetting the graphene-based precursors with water, rapidly freezing the graphene-based precursors after the wetting step to cause expansion of a water volume within the graphene-based precursors to cause defects within the graphene-based precursors, and thawing and removing the water from the graphene-based precursors.

### TECHNICAL FIELD

The present disclosure relates to graphitic precursor structures for a catalytic support component fabrication, such as for fuel cells, and methods of their modification to alter one or more properties.

### BACKGROUND

Hydrogen technology such as fuel cells and electrolyzers are becoming increasingly popular due to their ability to convert chemical energy stored into electricity or vice versa, using water and hydrogen as media. Yet many challenges remain and pose a hurdle to their large-scale production. Besides the harsh environment of the fuel cells and electrolyzers resulting in material choice challenges, degradation of the components such as the catalysts and the membranes need to be resolved as the degradation affects efficiency of the hydrogen devices. Likewise, functional reliability and fabrication economics need to be improved.

### SUMMARY

In one embodiment, a method of increasing porosity of graphene-based precursors is disclosed. The method may include wetting the graphene-based precursors with water. The method may also include rapidly freezing the graphene-based precursors after the wetting step to cause expansion of a water volume within the graphene-based precursors to cause defects within the graphene-based precursors. The method may include thawing and removing the water from the graphene-based precursors. The wetting may include flooding the graphene-based precursors with liquid water having a temperature higher than 4° C. The wetting may include applying steam prior to flooding. The wetting may include only partial wetting of the graphene-based precursors. The rapid freezing and thawing may be repeated at least one time. The water may be mixed with glycerol. The method may also include decreasing water surface tension during the wetting. The rapid freezing may include tuning a rate of freezing to obtain a target ice crystal size.

In another embodiment, a method of tailoring porosity of a graphene-based precursor structure is disclosed. The method may include, based on a predetermined porosity value, changing initial porosity of a graphene-based precursor structure by wetting of an external and internal surface of the structure with water and subsequently rapidly freezing the structure to cause water expansion within the structure to cause changes in the structure's atomic lattice to reach the predetermined porosity value of the structure. The method may also include comprising thawing the frozen water. The method may further include repeating the freezing and thawing at least one time. The graphene-based precursor structure may be a mesostructure with a high surface area of about 500 to 3000 m²/g. The wetting may be conducted with water having a higher temperature than 4° C .to lower surface tension. The method may also include removing the frozen water via sublimation. The wetting may include wetting with steam followed by flooding. The changes in the structure's atomic lattice may include formation of nanoscale defects.

In an alternative embodiment, a method of increasing an amount of suitable catalyst sites in graphene-based precursor structures is disclosed. The method may include determining an initial porosity value of graphene-based precursor structures and comparing the initial porosity value to a predetermined porosity value. The method may also include wetting the graphene-based precursor structures with a fluid which expands when frozen. The method may further include repeatedly exposing the wetted graphene-based precursor structures to fluctuating temperatures including a step of rapid freezing followed by a step of thawing to cause expansion of the fluid within the graphene-based precursor structures resulting in creation of additional pores suitable for catalyst attachment within the graphene-based precursor structures. The method may also include measuring porosity of the graphene-based precursor structures. The method may also include comparing the measured value to the predetermined porosity value. The fluid may be water mixed with glycerol. The fluctuating temperatures may include a range of about −200° C. to 10° C. The additional pores may be in nanoscale.

### BRIEF DESCRIPTION OF THE DRAWINGS

FIG. 1 shows a schematic of a non-limiting example proton exchange membrane fuel cell; and

FIGS. 2A, B, and C show non-limiting examples of the complex graphitic structures according to one or more embodiments disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,”the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by. ” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more. ”The terms “one or more”and “at least one”include “plurality”as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Chemical and electrochemical systems utilizing hydrogen as a fuel source are considered the energy systems of the future either in direct hydrogen combustion engines or fuel cells. These hydrogen-producing devices are becoming increasingly popular due to their ability to produce clean energy. The systems may include fuel cells, electrolysis cells or electrolyzers, and battery cells. Fuel cells, or electrochemical cells, that convert chemical energy of a fuel (e.g. H₂) and an oxidizing agent into electricity through a pair of electrochemical half (redox) reactions, have become an increasingly popular hydrogen-fuel-generating technology. Fuel cells are now a promising alternative transportation technology capable of operating without emissions of either toxins or green-house gases. An electrolyzer is an electrochemical device designed to convert electricity and water into hydrogen and oxygen, which may be in turn used to store energy. The electrolyzer utilizes electrolysis for hydrogen production. Besides fuel cells, the electrolyzer may be utilized in other applications including industrial, residential, and military applications and technologies focused on energy storage such as electrical grid stabilization from dynamic electrical sources including wind turbines, solar cells, or localized hydrogen production.

Non-limiting examples of fuel cells include proton exchange membrane fuel cells (PEMFCs). Utilizing an electrochemical reaction of H₂ and O₂ gases, PEMFCs provide a practical energy efficiency of over 60% with H₂O as the only product. The fast diffusion of H-ions enables functional operation of the PEMFC at a relatively low temperature of about 100° C. In contrast, solid oxide fuel cells and molten carbonate fuel cells operate at about 600° C. and above.

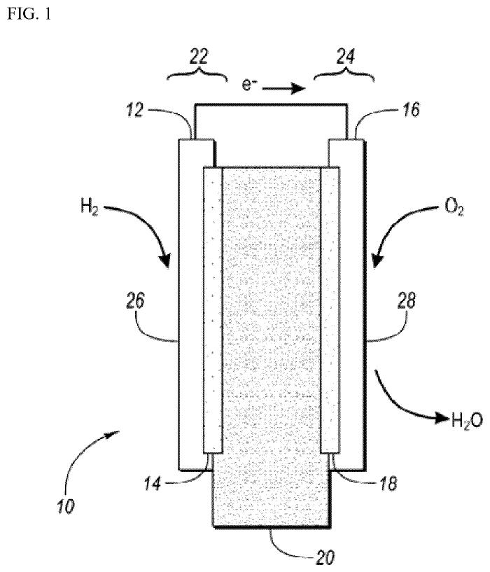

A non-limiting example of a fuel cell, a PEMFC is depicted in FIG. 1A. As shown in FIG. 1, PEMFC 110 includes anode catalyst support 112 coated with anode catalyst layer 114 formed of an anode catalyst material and cathode catalyst support 16 coated with cathode catalyst layer 118 formed of a cathode catalyst material. Polymer electrolyte material (PEM) 120 extends between anode catalyst support 112 and cathode catalyst support 116. The cathode catalyst material may be dispersed at an interface of PEM 120 and a current collector (not shown) supported by cathode catalyst support 118. The current collector may be a porous carbon current collector. Anode catalyst layer 114 is positioned between anode catalyst support 112 and PEM 120. Cathode catalyst layer 118 is positioned between cathode catalyst support 116 and PEM 120. Anode 122 may generally refer to anode catalyst support 112 and anode catalyst layer 114. Cathode 124 may generally refer to cathode catalyst support 116, cathode catalyst layer 118, and the current collector (not shown). PEMFC 110 also includes first and second gas diffusion layers (GDLs) (not shown). First GDL is adjacent outer surface 126 of anode catalyst support 112 and second GDL is adjacent outer surface 128 of cathode catalyst support 116.

Despite the benefits of PEMFCs, their high production price and relatively poor durability are limiting their application in energy plants and more affordable transportation technologies. For example, the platinum (Pt)/carbon (C) electrocatalysts in PEMFC cathodes cost at least half of the production price of a PEMFC, while the electrochemically active surface area (ECSA) of a Pt catalyst degrades severely (e.g., 50% or greater) during cycling.

Optimizing the microstructure of the catalyst support is a promising step for improving the durability of a PEMFC and decreasing the cost thereof. Various forms of carbon have been explored and tested for PEMFC applications including the catalyst support material. While many types of the support are carbon-based, research has confirmed that differences in the carbon structure, morphology, allotropic form, etc. influence properties and capabilities of the support. Hence, not only type of carbon, but also production conditions and changes influence applicability of the carbon for certain applications. For example, numerous graphene and graphite structures have been identified and can significantly differ in their properties such as in conductivity, elasticity, tensile strength, thermal conductivity, etc.

Optimization of the carbon support for a Pt catalyst is a promising step for improving the durability of a PEMFC, as well as other electrochemical devices utilizing a carbon-based electrocatalyst support, and decreasing the cost thereof. A correlation of the surface area of a carbon support with the ECSA of a Pt catalyst deposited on a carbon support may be considered in the optimizing step. For instance, the larger the surface area of the carbon support, the larger the ECSA of Pt catalysts deposited on the carbon support, when the same weight percentage of Pt loading is applied. This trend may be attributed to the uniformly small (e.g., a mean diameter of about 3 nm) size and an even distribution of Pt nanoparticles on carbon support with a relatively high surface area. Though a Pt/C electrocatalyst with a high surface area carbon (HSAC) achieves a relatively high ECSA with a lower amount of Pt loading, Pt/C electrocatalysts with HSAC still suffer from the same or similar severe degradation in ECSA during cycling as Pt/C electrocatalysts with low surface area carbon (LSAC). One proposal to improve cycle stability of Pt/C is to replace oxidative amorphous carbon with less reactive graphitized carbon.

One proposal to fabricate a graphitic carbon with a relatively high surface area includes a silver templating method. According to this method, a mesoporous carbon nano-dendrite (MCND) structure is synthesized to have primary particles with bubble-like hollow graphitic carbon nanoparticles (HGCNs) with surface pores. While typical HGCNs have a wall thickness over 5 nm (e.g., over 10 graphite layers), a MCND structure may have a single-layer graphene wall, thereby leading to a very high surface area (e.g., 1,610 m²/g).

Yet, preparation of carbon precursors for the fabrication of the less reactive graphitized carbon with high surface area, for example amorphous carbon nanoclusters with a diameter smaller than 2 nm, has proven to be difficult. The difficulty in graphene production has typically been connected to scalability and requirements for defect-free graphene material. Specifically, producing graphene in various configurations utilizing basic mechanical and chemical methods, which are scalable, remains to be a challenge.

In one or more embodiments, a method for producing carbon precursors for graphitized carbon catalyst support fabrication is disclosed. In a non-limiting embodiment, the process, described in detail below, includes a step of utilizing graphene flakes with defects, modifying the graphene flakes with additional carbon structures, optionally introducing additional defects, and crumpling the modified graphene flakes into carbon precursors.

The resulting carbon precursors may include crumpled modified graphene structures. The resulting carbon precursors may include graphitic carbon nanoparticles with a single-layer graphitic structure such as a shell or a wall. The precursors may include a single-layer structure. The precursors may include 2-D material, near 2-D material, or both. The precursors may include graphitic nanoparticles having one or more graphite materials such as a crystalline form of carbon atoms formed in hexagonal structures, amorphous carbon structures, nanoclusters or carbon materials having one or more dimensions in a nanoscale range of 1 to 100 nanometers, onion-like graphitic carbon mesostructures, hollow irregularly-shaped mesostructures, or a combination thereof. The carbon precursors may include crystalline structures, amorphous material, or a combination thereof. The carbon structures may include complex structures with torturous geometry, a plurality of twists and turns within the undulating surface topology resulting in presence of pockets, caves, curvatures, and varied orientation of the internal and external surface.

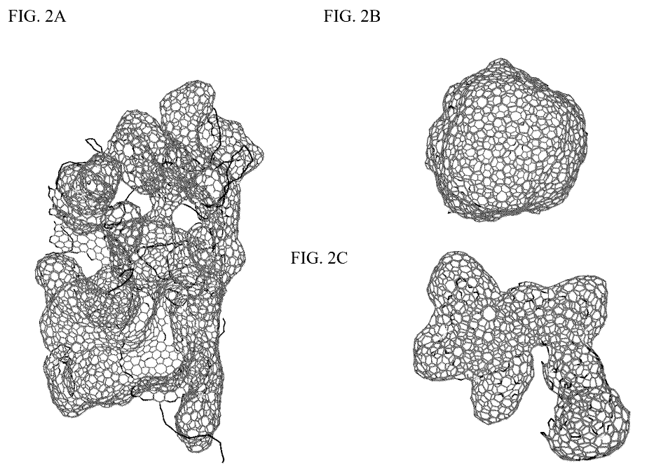

The carbon precursors may include structures in the nanoscale, mesoscale, microscale ranging from nanometers (10⁻⁹ meters) to micrometers (10⁻⁶ meters), or a combination thereof. The structures may be irregular, non-symmetrical, curved, having one or more curvatures, undulations, holes, voids, defects, or a combination thereof. The structures may include an irregular amount of pentagons and heptagons throughout the structures or at the structures edge(s). Non-limiting example structures disclosed herein are shown in FIGS. 2A, 2B, and 2C.

The carbon precursors may have a very high surface area in a range of about 500 to 3000, 800 to 2500, or 1000 to 1400 m²/g. The very high surface area may be about, or at least about 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, or 3000 m²/g.

The carbon precursors may have a density of about 0.7-3.5, 0.9-3.2, or 1.2-3.0 g/cm³. The density may be about, at least about, or at most about 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 g/cm³.

The carbon precursors may be utilized for production of one or more components of a chemical or electrochemical device such as a PEMFC schematically depicted in FIG. 1. A non-limiting example use of the carbon precursors fabricated according to one or more embodiments disclosed herein may include high surface area carbon applications, carbon support for an electrocatalyst in a fuel cell cathode, anode materials, carbon materials for super capacitors, lithium ion battery, lithium air battery, CO₂ reduction cell, etc.

Unlike in many previously explored applications, the carbon structures may have defects which are purposefully utilized as part of the fabrication process disclosed herein.

The process may include multiple steps. The first step may include obtaining graphene as a single layer atomic carbon 2D material, low number multi-layer graphene material including a few-layered graphene sheets with number of layers not exceeding 10, or a combination thereof. Graphene is a 2D carbon substance in which each carbon atom bonds three nearest-neighbor carbon atoms with sp² hybridization of 2s, 2pₓ, and 2p_{y} orbitals and 2p_{z} orbitals forms a delocalized π and π* bands perpendicular to the graphene plane. Graphene is a two-dimensional crystal, a solid material containing a single layer of atoms arranged in an ordered pattern. Due to its 2D character, graphene has strong bending fluctuation characterized by ripples and corrugations. Pristine graphene is non-magnetic and has zero-band gap.

The process may include a step of exfoliating graphite to obtain a plurality of graphene flakes. The exfoliating may be mechanical, liquid-phase exfoliation, layer-engineered exfoliation, large scale chemical vapor deposition, or the like.

The graphene flakes may include one or more structural defects such as topological defects, single-vacancy, multiple-vacancy, multi-layer flaking, foreign atoms, substitutional impurities such as B, N, line defects, grain boundaries, stacking faults, interruptions in the lattice, Stone-Wales defects or crystallographic defect including rotation of two-bonded carbon atoms resulting in distortion of the hexagonal network, irregularities in the lattice, edge defects, edge reconstructions, grain boundaries, dislocations, distortions, dangling bonds, the like, or their combination. The defects may be 2D, 3D, or both. The defects may be intrinsic, extrinsic, or both.

The process may utilize the exfoliated graphene flakes with and/or without defects. The utilization may be without discrimination, thus utilizing any or all of the graphene flakes obtained in the exfoliation step. Alternatively, the process may utilize more than 25%, 50%, 75% of graphene flakes with defects, the remainder being defect-free graphene flakes. The process may utilize only pristine graphene flakes with no defects. Yet, graphene flakes with defects are preferred. The process may utilize only graphene flakes with a certain type of defect named above.

The process may include selecting graphene flakes based on one or more parameters, for example a final target density of the precursor (for instance in the range of 1 to 3.5 g/cm³). In a non-limiting example, if the target precursor structures are to be onion-like graphitic carbon mesostructures, the exfoliated graphene sheet with a higher density towards the 3.5 g/cm³ may be chosen. In another non-limiting example, if the target precursor structures are single layer graphitic carbon mesostructures, the exfoliated graphene sheet with a lower density towards the 1 g/cm³ may be chosen. Another parameter may be a size of the graphene flakes influencing the final size of the precursor structures. The graphene flakes may measure about 0.005 to 500×10⁴, 0.05 to 500×10³, or 0.5 to 500×10² μm².

In a subsequent step, the process may include modifying the graphene flakes. The process may include decorating the graphene flakes with one or more deposited structures. Decorating relates to a deposition of material. The decorating may be performed to ensure a specific length scales, to avoid stacking of the graphene and graphene-like flakes into higher degree layers that would not anneal into the desirable structures, to target a specific amorphous structure density disclosed above, or a combination thereof. The deposited material may agglomerate on the surface of the graphene flakes. The deposition step results in an introduction of heterogeneity in pore size distribution of the graphene flakes, and ultimately of the graphitic precursor structures. In turn, the heterogeneity in pore size distribution can provide preferential pathways for water and gas transport in the catalyst layer of a PEMFC. For instance, large pores are preferred for water accumulation and the nano pores are available for gas transport.

The deposited structures may include non-graphene carbon structures. Non-limiting example structures may include nano-structures, fullerene or fullerene-like carbon balls such as C60 (soccer-ball-shaped molecule consisting of 60 carbon atoms) to C80, Buckminsterfullerene, linked ball and chain dimer, heterofullerene, endohedral metallofullerene, fullerenol, buckyball clusters, carbon nanorods, carbon nanotubes, both single-walled and multi-walled, with armchair or zigzag configuration, spherical nano carbon, or their combination. A fullerene is an allotrope of carbon whose molecules consist of carbon atoms connected by single and double bonds to form a closed or partially closed mesh, with fused rings or five to seven atoms. A carbon nanorod is an elongated particle ranging from about 10 to 120 nm with specific surface area of about 30-70 m²/g. A carbon nanotube is an allotrope of carbon, a tube made of carbon with a diameter in the nanoscale and a regular hexagonal lattice. The non-graphene carbon structures may include one or more defects disclosed herein. At least about 1, 5, 10, 15, 20, 25, 30, 35, 40, 45, 50, 55, 60, 65, 70, 75, 80, 85, 90, 95, or 100% may include at least one defect, based on the total amount of the non-graphene carbon structures being deposited.

Since the graphene and graphene-like structures typically display high degree or rigidity, the process may include a secondary modification step. The secondary modification step may be performed to enhance the effect of the subsequent crumpling step. The secondary modification step may include introduction or induction of additional defects within the graphene and graphene-like structures. The additional defects are focused on enablement of bending of the graphene sheets. The secondary modification step may include etching of the graphene structures with acid, water vapor, plasma, or a combination thereof. The process may include controlling additional defect density to control the shape of the carbon nanostructures. For example, introducing a high defect density may result in small primary structures while a low defect density may result in larger primary structures. The additional defects may further serve as the catalyst attachment sites, improve the ionomer interaction of the catalyst, thus improving the catalyst layer quality, or both.

The process may subsequently include a step of crumpling the modified graphene flakes disclosed above. Crumpling may refer to a process of graphene's structure deformation which may result in formation of crumples within the graphene structure, deformation from 2D to 3D structure, crumpled shapes, folds, or the like. A crumpled graphene includes graphene flakes which are bonded by weak van der Waals forces.

The crumpling step may include decorated graphene flakes with or without defects, non-decorated graphene flakes with or without defects, or their mixture. The crumpling may be induced by the presence of polar solvents, i.e., water, alcohols, or acetone, as the polar interactions between solvent and graphene induce the crumpling in unsupported graphene, electrical charging of the graphene layers, a modification of the polarity/interaction of the solvent via additives, such as organic or inorganic salts, mechanical means, i.e., ball milling, or wet/dry mixing, or a combination thereof. The crumpling step results in a crumpled modified graphene or graphene-like precursor material as disclosed herein.

Presence of defects, primary and additional, as described herein, may provide additional sites prone to deformation during the crumpling step. Since, due to the defects, the graphene hexagonal lattice may have structural deviations undermining strength, the defect locations may deform differently from the remainder of the lattice, potentially contributing to additional bends, folds, or deformations within the crumpled structures.

The crumpled structures may be subsequently annealed. Annealing is a post-processing treatment conducted for a variety of reasons, for example to remove any residues from a solvent application. Annealing may be thermal annealing, rapid thermal annealing, current annealing, or the like. Annealing may be performed at temperatures of about 200-2800, 500-1500, or 800-1200° C. Annealing may be performed under high vacuum or reducing gas atmosphere such as Ar, H₂, N₂, or a combination thereof.

The process may include one or more steps of verifying density of defects in the unmodified graphene flakes, density of defects in the modified graphene flakes, density of defects in the resulting crumpled precursor structures, density of the carbon precursors, porosity of the carbon precursors, the like, or a combination thereof. The verification may be done, for example, by transmission electron microscopy, Raman spectroscopy, or electron energy loss spectroscopy.

The process may include a step of changing, adjusting, increasing, maintaining, or keeping the density, defect density, porosity, surface area, or a combination thereof of the graphene flakes or the resulting carbon precursors. The process may thus include setting a predetermined target value for the density, defect density, surface area, porosity, or a combination thereof of the graphene flakes or the resulting carbon precursors, measuring or assessing the target value during and/or after the fabrication process, monitoring if the predetermined target value is met during the process, and correcting the target value by adjusting the process such as repeating one or more steps, taking a corrective action to meet the predetermined value, or a combination thereof.

The process may include introducing a predetermined amount of defects and or additional defects into the graphene flakes. The predetermined amount may relate to a percentage of flakes affected by the defects and/or additional defects. The percentage may be about, at least about, or at most about 1, 5, 10, 15, 20, 25, 30, 35, 40, 45, 50, 55, 60, 65, 70, 75, 80, 85, 90, 95, or 100%, based on a total amount of graphene flakes available for the process. The predetermined amount may relate to any amount of defective graphene flakes resulting from a deliberate step of including defective graphene flakes or not removing or excluding defective graphene flakes from the graphene flakes to be decorated, crumpled, or both.

The process steps described above may be performed before any catalyst deposition. Hence, the resulting carbon precursors may be free of any catalyst materials such as noble metals, specifically Pt, Pd, their oxides, or their combination. The catalyst may be deposited onto the precursors at a later stage of processing.

The modification of the graphene as disclosed herein affects the arrangement, structure, and properties of the resulting precursor structures. The crumpled modified graphene precursors disclosed herein may, as a result of the process disclosed herein, include undulations, pockets, caves, shapes, and folds configured to capture and retain an electrocatalyst. For example, the precursors may include crumpled partially closed fused carbon rings, pentagonal and heptagonal rings within the hexagonal lattice, an undulating, predominantly hexagonal net, with interruptions such as trenches throughout the net, deformation to a predominantly flat graphene lattice including sphere-like bulges, lumps, waves, pores, holes, the like, or a combination thereof.

The amount of such catalyst-holding spots within the precursor structures is enhanced compared to non-modified crumpled graphene and planar graphene sheets. The herein-disclosed crumpled structures may thus include a plurality of sites with high affinity towards an electrocatalyst.

Typically, the structures which serve as precursors for carbon-based components fabrication feature relatively low accessibility, for instance, of their internal surface to the catalyst. While the method of their preparation described above contributes to increased topological deviations, resulting in a greater than normal amount of sites with high affinity for electrocatalysts, there is a need to develop a method for increasing internal surface accessibility for carbon precursors prepared by alternative or traditional methods as well.

Additionally, the problem of lack of site accessibility is exacerbated with structures having a multi-layer configuration such as onion-layered mesostructures. This problem may arise if instead of a single layer graphene, a multi-layer graphene is used in the fabrication process of the precursors.

In turn, the activity of a whole electrochemical cell may be affected due to insufficient amount of catalyst being deposited and/or higher concentrations of catalyst being confined in smaller support areas. Thus, the catalyst particles may be more prone to merging and forming undesirable bigger catalyst agglomerations or conglomerates that have lower electrochemically active surface area per volume.

Thus, there is a need to develop a method resulting in a better distribution of the catalyst within available surfaces of the carbon precursors.

In at least one embodiment, a method of increasing accessibility of an internal surface of a graphitic carbon precursor structure is disclosed. The graphitic structures may be the structures described above, or any graphitic or graphene-based structures serving as precursors for fabrication of carbon components in electrochemical or chemical devices such as a PEMFC. The structures may be free of defects, include defects, topological abnormalities to the lattice, have amorphous configuration, be irregular, non-symmetrical, curved, have one or more curvatures, undulations, holes, voids, etc. The structures may have dimensions in the nanoscale, mesoscale, or microscale ranging from nanometers (10⁻⁹ meters) to micrometers (10⁻⁶ meters). The structures may have high surface area, density, and other properties disclosed herein.

The method may include one or more steps described herein. At least some of the steps may be repeated one or more times. The method may include one or more cycles. The method may include 1-10, 2-8, or 3-6 cycles.

The method may include utilizing the unique volume-temperature properties of water, specifically the anomalous expansion of water. It is well-known that above 4° C., the volume of water increases with increasing temperature, but below 4° C., the volume of water increases with decreasing temperature. Thus, water expands instead of contracts when the temperature drops below 4° C. and reaches 0° C.. This behavior makes water less dense, and at 0° C., water reaches its maximum volume as ice. In other words, in the −10 to ±10° C. range, the minimum volume of water (or maximum density of water) is achieved at 4° C. Hence, below 4° C., water confined to a space expands and may damage the boundaries of the enclosed space holding the water.

In an initial step, the method may include wetting the precursors or providing water into a volume containing the low-accessibility precursors. The volume may be fully or partially enclosed in a container. Providing may include flooding, filling with liquid water, supplying water vapor, steam, spraying, or a combination thereof. Providing may mean accumulating water until at least a portion or all portions of the precursors are submerged in the water. The providing may be conducted at the water's maximum density point at about 4° C. The providing may be tailored and include selecting predetermined areas of the precursors to be opened or made more accessible to the catalyst, electrolyte, the like, or a combination thereof. The wetting may include wetting of an internal surface, external surface of the structures, or both.

The method may include one or more ways to decrease water surface tension. For example, the method may include using water having a higher temperature than 4° C. as higher temperatures translate to lower surface tension. In another example, the method may include using one or more additives designated for this purpose such as one or more surfactants. In yet another example, the method may include electrowetting or applying voltage to the system causing a change in the water wettability from the applied electricity.

In a subsequent step, the method may include rapidly freezing the wetted precursors. The step may also include thawing, melting, or sublimation without thawing or melting. The temperature fluctuation may be in a temperature range of about −200° C. to about 10° C., about −195° C. to about 4° C., or about −150° C. to about 0° C. The freezing and thawing temperatures the system is brought under may be about, at least about, or at most about −200, −190 , −180, −175, −170, −165, −160, −150, −145, −140, −135, −130, −125, −120, −115, −110, −105, −100, −95, −90, −85, −80, −75, −70, −65, −60, −55, −50, −45, −40, −35, −30, −25, −20, −15, −10, −5, 0, 1, 2, 3, 4, 5, 6, 7, 8, 9, or 10° C. The method may include fast freezing, flash freezing, external freezing, using liquid nitrogen, or another way to rapidly freeze the wetted precursors. Flash freezing relates to rapid freezing involving cryogenic temperatures or direct contact with liquid nitrogen at −196° C. The rapid freezing may relate to instant freezing within a few seconds to a time frame of about 30 to 60 s. Hence, rapid freezing may be about 1 to 90, 10 to 60, or 20 to 30 s. The rapid freezing may be about, or at most about 1, 2, 3, 4, 5, 6, 7, 8, 9,10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40,41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 s.

The freezing causes expansion of the water within and around the precursors. The size of the formed ice crystals is a function of the freezing speed. A faster freezing may produce smaller ice crystals, which are desirable to generate small breaks in the precursor material. Rapid freezing thus causes growth of ice crystals throughout the structures including the inaccessible areas which are the main target of the disclosed process. In contrast, a slow freezing process could result in growth of macro-crystals and potentially growth of ice crystals outside of the pores and cavities of the precursor structures, which is not desirable.

The method may thus include a step of tuning, maintaining, adjusting, or changing the rate of freezing to obtain ice crystals with a predetermined or target size. The target size may be in nanoscale, microscale, or both.

Subsequently, the method may include thawing or warming of the frozen precursors. The thawing may be done rapidly, slowly, at once, in stages, steadily, gradually, slower than the freezing by about 25, 50, 60, 70, 80, or 90%. Preferably, the thawing is done steadily and slowly. Alternatively, the method may include a step of sublimation or turning the frozen liquid into a gaseous state without the fluid becoming a liquid.

The change in volume of the water, due to the change of temperatures, is utilized to damage the low-accessibility structures, breaking the structures, and rendering the structures more open or accessible, causing formation of mechanical defects. The cracking and breaking generated via the flash freezing may expose previously inaccessible areas. The cracking and breaking may alter the shape of the structure including changes in the quantity and/or dimension of pores, angles between portions of the structures, breaking of the lattice, formation of trenches and holes within the lattice, increasing distance between layers of the multi-layer structures, the like, or a combination thereof. The process may increase porosity, decrease density, or both.

The rapid freezing and warming may be repeated several times. For example, the cycle of freezing and thawing may be repeated once, twice, 3, 4, 5, 6, 7, 8, 9, 10, or more times. The repetition may be especially useful with precursors such as multi-layer, onion-like graphitic shells that might be more difficult to access with a single flash freezing procedure. The repeated cycles may progressively render the graphitic carbon structures more accessible. The last warming stage may be protracted in time to facilitate draining of water from the system.

The method may include removing of the water from the structures. Removing may include draining, drying, the like, or a combination thereof. The removal may be rapid of slow.

Water is a suitable fluid to implement in this method for several reasons. Firstly, water's expansion anomaly described above. Secondly, water presence is normal in a fuel cell operation, thus minimizing the risk of contamination. Other fluids which expand their volume when frozen are also contemplated, for example gallium. Yet, suitability of some of the substances may not be suitable for a fuel cell environment.

The type of water used for this method may be tailored based on the target results. For example, pure or deionized bulk water may be used to flood the structures and cause formation of crystals in the order of a few microns. The water may be a tap water or be filtered or otherwise relatively free of minerals. Water including minerals is also contemplated, but presence of the minerals may lower the freezing point. The water may include additional components such as glycerol, glycerine, the like, or a combination thereof.

Upon freezing and thawing, the crystals may cause cracking in the micro scale. Alternatively, smaller crystals in the nanoscale, and thus smaller cracks of the carbon structures in the nanoscale, may be induced by water mixed with glycerol. Additionally, the structures may be first exposed to steam to be just partially wet with pure water to cause cracking in only portions of the structures. The method may thus include a step of selecting, determining which portions of the structures to open or make more accessible, which size of the cracks are desirable, or both. The method thus allows for tailoring of the result based on a specific application.

Additionally, the method may include selecting, measuring, assessing, checking, managing, or changing porosity of the structures based on a predetermined value. The method may include a repeated checking of the porosity distribution, density, or both throughout the process. The method may include adding another cycle of freezing/thawing if the porosity should be increased to meet the predetermined target value. The method may include assessing initial porosity and increasing porosity of the structures based on the initial porosity value.

As was disclosed above, since the graphene-like structures of the precursors are quite rigid, the method may include the step of introducing defects. A more defective structure may be prone to better wetting. The method may thus include increasing incidence of defects within the structures by one or more steps disclosed herein.

Accessibility of the discussed structures may be increased by an alternative method described herein. The alternative method may be used instead or in addition to the freeze-thaw method. The method may include one or more steps described herein. The method may include voltage-induced platinum ion bombardment of the structures.

The method may include preparing atoms of the electrocatalyst. The electrocatalyst may be Pt, Pd, their oxides, their alloys, or their combination. The preparing may include depositing or growing the catalyst atoms into congregations or agglomerates including nanoclusters, clusters, small nanoparticles measuring less than about 250 atoms, or their combination. While the term “agglomerates” is used herein, congregations, clusters, nano clusters, and small nanoparticles measuring less than about 250 atoms, or their combination are likewise covered by the disclosure. The agglomerates or clusters may be mono-dispersed or near mono-dispersed referring to a relatively small size variation between the agglomerates. The size distribution may vary between about 10 s to 100 s of atoms. In a non-limiting example, the size distribution may encompass agglomerates or clusters measuring less than 25 atoms to more than 100 atoms. The agglomerates or clusters may be also poly-dispersed such that the size distribution of the agglomerates or clusters is greater than in the mono-dispersed group.

Once the agglomerates or clusters are formed, the method may include sorting or selecting agglomerates or clusters based on one or more criteria. The criteria may include targets disclosed herein. In addition, the criteria may include considerations such as efficiency. For example, smaller agglomerates or clusters, such as those in the 10 s of atom, may be easier to sort due to their lower mass and easier to accelerate due to lower voltage requirements.

The method may include applying voltage to the agglomerates or clusters to accelerate the catalyst agglomerates or clusters towards the precursor structures. In a non-limiting example, the voltage may be provided by a static, van de Graaff-type accelerator. The acceleration may result in bombardment of the structure with the agglomerates or clusters. The bombardment may result in penetration of at least a portion of the agglomerates or clusters in the structure's surface and mass. The penetration may reach a certain depth discussed below. The bombardment may result in significant mechanical deformations and defects of the structures, thus deforming the lattice, forming holes, trenches, increasing distance between layers of the structure, and the like, and in turn increasing accessibility of the surfaces to the catalyst.

The energy imposed on the agglomerates or clusters may be either constant regardless of agglomerate or cluster size or constant per atom. The method may include ionizing the structures. The method may thus include generation of an equi-energy beam of ions to produce a constant energy regardless of agglomeration or cluster size or generation of equi-velocity beam to produce a constant energy per atom. In the case of near mono-dispersed agglomerates or clusters, equi-energy equals equi-velocity as the agglomerates or clusters are made of nearly the same number of atoms. In the case of poly-dispersed agglomerates or clusters, equi-energy does not equal equi-velocity. The term “equi” relates to the term equal from the Latin term aequi. Alternatively, the agglomerates or clusters may be mono-dispersed by glow discharge at high voltage disclosed herein or arc discharge.

Non-limiting example voltage and energy/atom ranges may be about 1 to 10, 2-8, or 3-7 MV and 10 s of keV/atom to 10 s of MeV/atom such as 10 keV to 99 MeV/atom, 30 keV to 70 MeV/atom, or 40 keV/atom to 60 MeV/atom. The voltage and energy/atom may be about, at least about, or at most about 1, 1.5, 2, 2.5, 3, 3.5, 4, 4.5, 5, 5.5, 6, 6.5, 7, 7.5, 8, 8.5, 9, 9.5, or 10 MV and 10, 15, 20, 25, 30, 35, 40, 45, 50, 55, 60, 65, 70, 75, 80, 85, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 3000, 4000, 5000, 6000, 7000, 8000, 9000, 10000, 15000, 20000, 30000, 35000, 40000, 45000, 50000, 55000, 60000, 65000, 70000, 75000, 80000, 85000, 90000, 95000, or 99000 keV/atom.

A depth at which an agglomerate or cluster will stop in its travel through the carbon structure is a function of the energy of the agglomerate or cluster. The following cases are thus relevant:

(A) Mono-dispersed agglomerates or clusters and equi-energy (or equi-velocity). In this case, agglomerate or cluster bombardment will generate a near-uniform size population of deposited catalyst at a near-uniform depth in the carbon structure;

(B) Poly-dispersed agglomerates or clusters and equi-energy. In this case, a non-uniform size population of deposited catalyst is deposited at near-uniform depth in the carbon structure; and

(C) Poly-dispersed and equi-velocity. In this case, a non-uniform size population of deposited catalyst is deposited at non-uniform depths in the carbon structure.

The term “near-uniform” may relate to a deviation of about ±1 to 5% from the average value. For example, a near-uniform size population may relate to the average size about ±1 to 5% of the average size. For example, a near-uniform depth may relate to the average depth of the deposited agglomerates about ±1 to 5% of the average depth, thus covering additional agglomerates or clusters within the deviation range.

The method may include providing or selecting a predetermined depth or depths at which the agglomerates or clusters should be deposited. The predetermined targets may be set based on a number of factors such as the degree, quantity, location of desired mechanical defects, target porosity value of the carbon structure, target quantity and location of the catalyst within the carbon structure, distribution of the catalyst within the carbon structure, the like, or a combination thereof. A non-limiting example target size of the deposited agglomerates or clusters may be about 100 s to 1000 s of atoms such as a range between 100, 200, 300, 400, 500, 600, 700, 800, 900, 1000, 1500, 2000, 2500, 3000, 3500, 4000, 4500, 5000, 5500, 6000, 6500, 7000, 7500, 8000, 8500, 9000, or 9500 atoms. A non-limiting example target diameter of deposited agglomerates or clusters may be about 2 to 5, 2.2 to 4.8, or 2.5 to 4.5 nm. The diameter may be about, at least about, or at most about 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5 nm.

The method may further include assessing, measuring, scanning the penetration quality, quantity, and depth. Where a uniform-depth penetration in the structure results, a voltage scan may be used to access progressively deeper/stronger areas of the structure. The term stronger refers to a harder-to-access area in a multi-layer configuration.

The step of voltage application and bombardment of the carbon structure with the agglomerates or clusters may be repeated, for example 1, 2, 3, 4, 5, 6, 7, 8, 9, 10, or more times. The repeating may be conducted with the same or different agglomerates or clusters differing in their particle distribution, chemistry, average size. The repeating may be conducted with the same or different equi energy, equi velocity as the previous round of application. The repeating may be conducted until one or more predetermined target(s) are met.

The repeating may include bombarding the carbon precursor and forming a layer of the electrocatalyst on the precursor. The method may further include additional depositions of the carbon precursor followed by additional bombardment with the electrocatalyst. The process may repeat until a desirable amount of layers and/or electrocatalyst loading is achieved.

The method may include annealing to increase mobility of deposited catalyst agglomerates or clusters, to promote small agglomerates or clusters to merge into bigger ones until the desired target size is achieved, to repair any damage to the crystalline structure of the agglomerate or cluster, the like, or a combination thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of increasing porosity of graphene-based precursors, the method comprising:
(a) wetting the graphene-based precursors with water;
(b) rapidly freezing the graphene-based precursors after the wetting step to cause expansion of a water volume within the graphene-based precursors to cause defects within the graphene-based precursors; and
(c) thawing and removing the water from the graphene-based precursors.

2. The method of claim 1, wherein the wetting includes flooding the graphene-based precursors with liquid water having a temperature higher than 4° C.

3. The method of claim 1, wherein the wetting includes applying steam prior to flooding.

4. The method of claim 1, wherein the wetting includes only partial wetting of the graphene-based precursors.

5. The method of claim 1, wherein the rapid freezing and thawing is repeated at least one time.

6. The method of claim 1, wherein the water is mixed with glycerol.

7. The method of claim 1, further comprising decreasing water surface tension during the wetting.

8. The method of claim 1, wherein the rapid freezing includes tuning a rate of freezing to obtain a target ice crystal size.

9. A method of tailoring porosity of a graphene-based precursor structure, the method comprising:
based on a predetermined porosity value, changing initial porosity of a graphene-based precursor structure by wetting of an external and internal surface of the structure with water and subsequently rapidly freezing the structure to cause water expansion within the structure to cause changes in the structure's atomic lattice to reach the predetermined porosity value of the structure.

10. The method of claim 9, further comprising thawing the frozen water.

11. The method of claim 10, further comprising repeating the freezing and thawing at least one time.

12. The method of claim 9, wherein the graphene-based precursor structure is a mesostructure with a high surface area of about 500 to 3000 m²/g.

13. The method of claim 9, wherein the wetting is conducted with water having a higher temperature than 4° C. to lower surface tension.

14. The method of claim 9, further comprising removing the frozen water via sublimation.

15. The method of claim 9, wherein the wetting includes wetting with steam followed by flooding.

16. The method of claim 9, wherein the changes in the structure's atomic lattice include formation of nanoscale defects.

17. A method of increasing an amount of suitable catalyst sites in graphene-based precursor structures, the method comprising:
determining an initial porosity value of graphene-based precursor structures and comparing the initial porosity value to a predetermined porosity value;
wetting the graphene-based precursor structures with a fluid which expands when frozen;
repeatedly exposing the wetted graphene-based precursor structures to fluctuating temperatures including a step of rapid freezing followed by a step of thawing to cause expansion of the fluid within the graphene-based precursor structures resulting in creation of additional pores suitable for catalyst attachment within the graphene-based precursor structures;
measuring porosity of the graphene-based precursor structures; and
comparing the measured value to the predetermined porosity value.

18. The method of claim 17, wherein the fluid is water mixed with glycerol.

19. The method of claim 17, wherein the fluctuating temperatures include a range of about −200° C. to 10° C.

20. The method of claim 17, wherein the additional pores are in nanoscale.
